(19) United States
(12) Patent Application Publication
(10) Pub. No.: US 2004/0142306 A1
(43) Pub. Date: Jul. 22, 2004

(54) Drawing and painting system

(76) Inventor: Paul R. Prince, Idyllwild, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/467,646

(22) PCT Filed: Feb. 9, 2002
(86) PCT No.: PCT/US02/03960

(51) Int. Cl. G09B 11/00

(52) U.S. Cl. 434/85

(57) ABSTRACT

A system for sketching, illustrating, drawing or painting a likeness composition such as a canvas oil painting from a source image is described, and includes a set of graduated reusable overlayable source image grids with subdivision indicators affixed to clear plastic sheets to be used with a corresponding destination canvas grid pattern, thereby allowing a consistent grid pattern for all canvas sizes. Such a system greatly simplifies the use of grids in producing artwork and provides a low cost timesaving method to draw accurate shapes. The system includes a unique pre-gridded canvas with a water soluble grid pattern that includes the image grid pattern, thereby facilitating the drawing of the source image onto the canvas and simplifying the removal of the grid pattern after the drawing is completed and prior to painting. A method for imprinting the grid pattern onto the canvas, and a method for using the system of the present invention, are also disclosed.

### PRIORITY CLAIMS

This application claims the benefit of U.S. Provisional Application No. 60/267,846 filed Feb. 10, 2001 entitled “Removable Gridding System,” the entire content of which is expressly incorporated by reference, U.S. Provisional Application No. 60/269,701 filed Feb. 16, 2001 entitled “Precision Drawing System,” the entire content of which is expressly incorporated by reference, U.S. Provisional Application No. 60/269,990 filed Feb. 20, 2001 entitled “Drawing System,” the entire content of which is expressly incorporated by reference, and U.S. Provisional Application filed Oct. 29, 2001 entitled “Gridding System with Washable Patterns,” the entire content of which is expressly incorporated by reference. The “Gridding System with Washable Patterns” was mailed on Oct. 20, 2001 US Certified Mail No. 7000 1670 0007 1605 7571 and the return receipt is stamped received at USPTO on Jan. 3, 2002.

### ASSIGNMENT

This application has been assigned to GRIDART, LLC, a Nevada limited liability corporation with main offices at 2988 Stonebridge Trail, Reno, Nev. 89511.

### REFERENCE

1) Copending U.S. patent application Ser. No. 09/717,586 for DRAWING AID, filed on Nov. 21, 2000, P. R Prince and M. Von Lortz, assigned to GRIDART, LLC a Nevada limited liability corporation with main offices at 2988 Stonebridge Trail, Reno, Nev. 89511.

### FIELD OF THE INVENTION

This invention relates to methods and apparatus useable in the fields of art and graphics. In particular the preferred embodiment of this invention allows a person to easily and accurately create a likeness of a source image, such as a photograph, onto a canvas.

### BACKGROUND AND RELATED ART

For many centuries mankind has performed drawing and painting for expression of experiences, communication, documentation, and cultural art. Often it has been desirable to generate works of art with accurate shapes and accurate perspective representations. The use of “gridding” or “squaring” has become commonplace for beginning art students as well as many professional artists for creating a likeness with accurate perspective and shape. Gridding involves dividing a source image into a number of rectangles or cells that are individually relatable to destination cells usually of a different size drawn upon a destination base such as a canvas, a process that is well known in the field of art. In the initial steps of creating a drawing or painting the general outline of the image in each cell is transferred into a corresponding destination base cell, sometimes including shading details. Any cell encompassing finer image detail regions may be subdivided into smaller cells, for example four, in order to facilitate accurate detail portrayal onto the destination base or canvas. The final work of coloring the drawing is then performed, typically without further need of grids.

Prior art includes a manual process of inking or penciling a grid pattern of equally spaced parallel lines and a pattern of normals, typically forming grids, or cells, onto the source image, and calculating and inscribing a corresponding grid pattern of cells upon the destination base or canvas. Drawing a representation of the source image from each cell of the source grid pattern into each corresponding destination base cell allows accurate relative positioning of the contents within the image cell-by-cell, leading to accurate perspective, shape, and three-dimensional representations.

Art and drawing texts, for example, Smith et al, An Introduction to Art Techniques, 1995 describe the process of manual gridding which involves time-consuming measuring and scaling of the original source such as a photograph, and carefully drawing horizontal and vertical grid lines, dividing the desired image area into an array of cells. The artist then calculates and marks all four edges of the destination base or canvas and later constructs interconnecting graduation lines to form intersecting row and column lines that form a grid pattern of cells to correspond, one-to-one, with the grid previously drawn onto the source image. Typically the destination canvas is larger than the source, but may be any size. The rows and columns are labeled on image grids and canvas grids numerically or alphabetically or both.

The aspect ratio height/width for rectangular canvas shapes must be similar for the source and the destination in order to provide a complete linear representation onto the destination base with respect to the source. Artists are taught to individually measure and draw these grid patterns, which is a laborious, tedious, and time-consuming process that can involve mistakes and require erasures. Often an artist will grid an image, then grid the canvas only to find that the desired composition is not correctly covered with the grid pattern. Then he must erase labels and grid lines and construct them again.

Artists are faced with confusing geometric calculations involving image size and shape, canvas size and shape and magnification, particularly in view of the wide variety of canvas sizes, shapes and aspect ratios. Many drawing textbooks suggest enlarging a source picture on a copy machine prior to gridding. All of these variables often cause artists to compromise their desired composition due to the complexities of gridding and preparing for drawing.

Ref. (1) describes a system of a series of image guides sharing a common aspect ratio and cell count, overlayable onto an image such as a photograph, and further describes methods for gridding destination surfaces such as canvases, walls, and other surfaces to provide for cell-by-cell reproduction, at the same or at different magnifications, of the image onto the destination surface. In that system, a method of gridding canvases involves the somewhat complicated use of a Canvas Table and a Canvas Ruler, manually drawing grid lines and labels, and manually erasing the grid lines and labels after creating the drawing, while taking care to not erase the drawing. What is needed are pre-gridded canvases with easily removed grid lines and labels to substantially simplify the drawing and painting process.

Further, when using the gridding system of Ref (1), it has been found easier for an artist to work with fewer grid cells than the 80 cell pattern, termed “series 80” in that reference. Moreover, with fewer cells, the artist is less inclined to forget which cell he is working on at any particular time. It would be beneficial to be able to use fewer cells while maintaining sufficient accuracy and precision, as is available, for example, with the 80 cell pattern. I have tried alternate grid lines, for example, as dashed grid lines so that an artist can ignore the dashed grid lines in regions of low image complexity, and utilize the dashed grid lines in regions of high complexity. Such a system has been found to become confusing and distracting, and complicates the labeling and tracking of rows and columns.

Furthermore, the methods for gridding canvases described in Ref. (1) produce optimum grid patterns only for a select group of canvas shapes, those of precisely the predetermined aspect ratio of the standardized image guides and of an integral multiple of certain fractions of an inch or other unit of measure. In general, resulting canvas grid patterns may contain fractional cells in both vertical and horizontal directions, causing an undesirable level of confusion for users of such systems. It has been found that confusion sometimes occurs when the composition frame of the image guides of Ref (1), when mentally projected onto a canvas, overlaps the canvas. Visualizing a composition projected onto a canvas has been found easier if a bold rectangular composition guide enclosing an image area of interest is fully contained within a canvas when projected thereon. Thus it is advantageous to view within a framework, the central focus of the composition outlined in a composition guide as opposed to the composition frame of Ref. (1) which may obscure areas of the subject image that lie underneath its frame. A composition guide would then be a representation of the central composition of the drawing, or a “focus” region, rather than a representation of a picture frame around the canvas, and use of the corner-guide of Ref (1) could be eliminated.

### SUMMARY OF THE INVENTION

A preferred embodiment of the present invention includes a series of improved image guides and optimized pre-gridded canvases wherein the preprinted canvas grid patterns that form cells, and labels, are substantially removable with water. The image guides provide a bold composition guide for identifying the majority of the composition, and subdivision reference indicators within cells and/or along grid lines allow for increased precision, while retaining the unthreatening appearance of a much smaller number of cells, such as 20 (here termed “series 20s”). The subdivision reference indicators along grid lines are termed side reference indicators and may be midpoint gaps in the sides of the cells, for example. The subdivision reference indicators within cells are termed internal reference indicators and may be center dots at the centers of each cell, for example.

The present invention also describes preferred canvas grid patterns that include detail subdivision marks at the canvas edges for allowing the user to detail-grid the canvas for regions of high detail using only a straight-edge and marker, and further describes a preferred water-washable ink that is soluble in water, the ink chemistry and preparation, and a description of a preferred method of ink application to canvases using commonly known silk screen processes.

The word canvas herein pertains to an artists canvas, typically made of canvas or polyester material over a wooden frame, drawing paper, watercolor paper, wall surfaces for murals, billboard surfaces, and any other destination surface for drawing or painting. The combination “canvas material” shall connote that the actual surface material is, in fact, canvas, whereas the term “canvas” is general. The two orthogonal directions of a rectangular canvas are termed vertical and horizontal, but do not necessarily pertain to the actual orientation of the canvas with respect to up and down. To simplify the discussion, the longer dimension of a rectangular canvas is termed its width and is considered horizontal. The shorter dimension is termed its height and is considered vertical. The aspect ratio of a rectangle is herein defined as the shorter side dimension divided by the longer side dimension.

To greatly simplify the drawing process it is beneficial to manufacture pre-gridded canvases so that users are not required to manually construct the grid pattern and labels. I tried silk screening very thin grid lines to minimize the paint thickness required to cover over the pre-printed grid patterns, using light blue color and also light color flat silk screen paint matching the canvas color. However, all attempts resulted in visible grid patterns showing through the painting, possibly due to the priming effect and the ink thickness. The pattern was visible from a glancing angle and clearly apparent when viewing specular reflections from the surface. The correlation of straight lines within the painted product was very objectionable.

My invention provides pre-gridded canvases wherein the grid pattern is formed with water soluble ink, thereby greatly simplifying the drawing process by eliminating the need for users to calculate grid patterns, or to refer to canvas tables or the like to determine appropriate scale markers or units of measure, or to manually draw grid lines upon canvases, and having to erase grid lines and labels after completing the drawing. Minimizing fractional or partial cell area advantageously eliminates partial cells in one of the orthogonal directions of the canvas for canvas shapes that differ in aspect ratio from the drawing system image guide aspect ratio. In this way the complete subject image within the composition guide may be reproduced on the canvas for better composition visualization.

This composition guide allows the artist to easily visualize the final composition of the image that will be transferred onto the canvas without concentrating on image grid lines, canvas grid lines, magnifications, and the like. The image transferred to the canvas may be larger, the same, or smaller than the original image size. A significant feature of this invention is that the image to be painted or drawn is configured with a grid pattern substantially identical to the grid pattern applied to the canvas, i.e., the invention provides identical arrays of cells and provides corresponding labels for both the image and the canvas, and thereby greatly facilitates the drawing process. Thus, for example, for a predetermined array of square cells such as four rows by five columns—there is no requirement for the user to calculate magnification ratios, analyze candidate grid or cell sizes, and construct grid patterns. Four by five square cells in an image guide relates to four by five square cells on any size 0.800 aspect ratio canvas, so that each has the same number, twenty cells total. The larger the canvas, the larger the canvas grid dimensions, always resulting in a canvas array of twenty cells. Likewise, the larger or smaller an image, the larger or smaller are its grid cells and composition guide when the proper sized image guide of a set is utilized. In this way, the four by five array pattern can be used for any canvas of that aspect ratio, and by choosing an image guide with its composition guide of the appropriate size, substantially any practical image size of that aspect ratio may be utilized as well.

A set of image guides with grid sizes 0.40 inch through 2.00 inches may include, for example, fifteen overlay sheets increasing in 12% linear dimension steps. In this way, an artist may compose an image with flexibility for increasing or decreasing its size in 12% steps in order to properly frame a desired region. For more flexibility, a set of twenty-nine uniform 6% size steps may be provided, for example.

Since all 0.800 aspect ratio canvas sizes require four rows and five columns if the cells are square, each such canvas size requires a unique grid size. Thus a 16 by 20 inch canvas will require a 4.00 inch grid spacing, and can be manufactured with that pattern and with labels. Likewise, for use with the above-described image guides, a 24 by 30 inch canvas will uniquely require 6.0 inch grid spacing. The canvases may be pre-printed with the water soluble ink without limiting the use of such canvases.

Other aspect ratio canvas shapes will require unique grid patterns when used with 4 by 5 shaped image guides. These can beneficially be calculated to provide the largest possible composition guide pattern on any particular rectangular canvas by adjusting the grid dimension until two edges of the composition guide pattern coincide with one pair of the canvas edges, either at the sides or at the top and bottom. In this way any fractional cell area is minimized. For further aiding in the transfer of a composition from an image onto a canvas, the remaining fractional cells may be evenly divided to each side, or to the top and bottom, so that the canvas composition guide is substantially centered within the canvas. It has been found that for most common aspect ratio canvas shapes, the canvas composition guide is then not required to be emphasized with bold lines, and may beneficially be eliminated where it coincides with the extreme canvas edges because the edges themselves form a virtual composition guide along those sides. Furthermore, all canvas shapes with the aspect ratio of the image guide composition guide, such as 0.800, may use the four canvas edges as the canvas composition guide, without printing along the canvas edges.

### BRIEF DESCRIPTION OF THE DRAWINGS

FIG. 1A illustrates a preferred image guide with 20 square cells, each cell having center dots and midpoint gaps.

FIG. 1B illustrates a reference to a detail guide, printed on image guides.

FIG. 1C illustrates a detail guide overlaying an image guide.

FIG. 2 illustrates a canvas of aspect ratio 0.800 with a pre-printed canvas grid pattern series 20s with 20 square cells, center dots, and midpoint gaps.

FIG. 3 illustrates a canvas of aspect ratio 0.750 with a projected representation of the composition frame of Ref. (1).

FIG. 4 illustrates the canvas of FIG. 3 gridded according to the canvas gridding methods of Ref. (1) series 20.

FIG. 5 illustrates the canvas of FIG. 3 gridded according to the present invention series 20s.

FIG. 6A illustrates the canvas of FIG. 5 for use with series 20s image guides, further including detail guide marks.

FIG. 6B is an enlarged view of detail guide marks.

FIG. 7 illustrates a preferred artwork pattern for canvasses with an aspect ratio of 0.750.

FIG. 8 illustrates a canvas of aspect ratio 0.833 gridded for use with series 20s image guides.

FIG. 9 illustrates a preferred artwork pattern for canvasses with an aspect ratio of 0.833.

FIG. 10 illustrates a preferred artwork pattern for canvasses with an aspect ratio of 0.800, including detail guide marks.

FIG. 11 illustrates a canvas of aspect ratio 0.625 gridded for use with series 20s image guides.

FIG. 12 illustrates a canvas of aspect ratio 1.00 gridded for use with series 20s image guides.

FIG. 13 illustrates a canvas of aspect ratio 0.500 gridded for use with series 20s image guides.

FIG. 14 illustrates a circular canvas gridded for use with series 20s image guides.

FIG. 15 illustrates the construction of a typical canvas with its canvas fabric partially removed to view the frame.

FIG. 16 illustrates the canvas of FIG. 15 in cross-section.

FIG. 17 illustrates the canvas of FIG. 16 placed upon a canvas fabric support fixture for use in silk screening the canvas.

### DETAILED DESCRIPTION OF THE PREFERRED EMBODIMENT

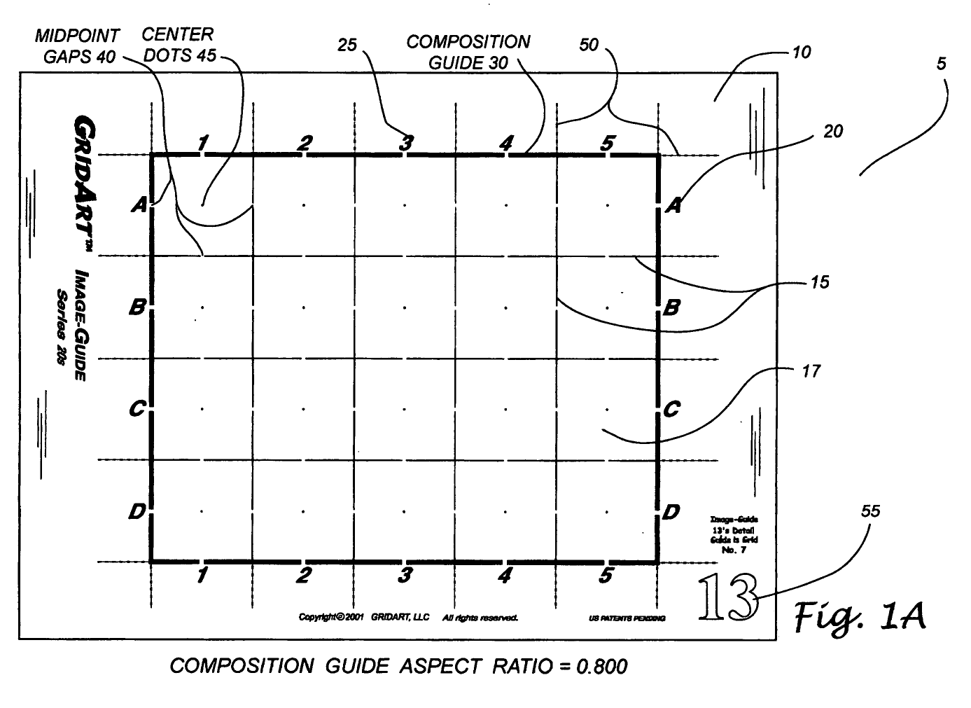

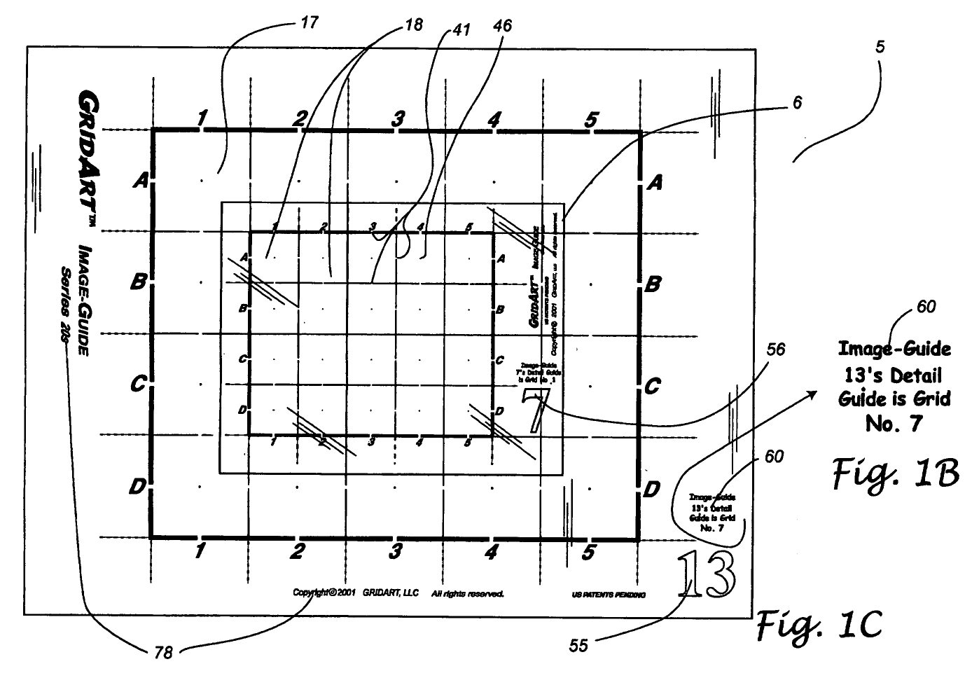

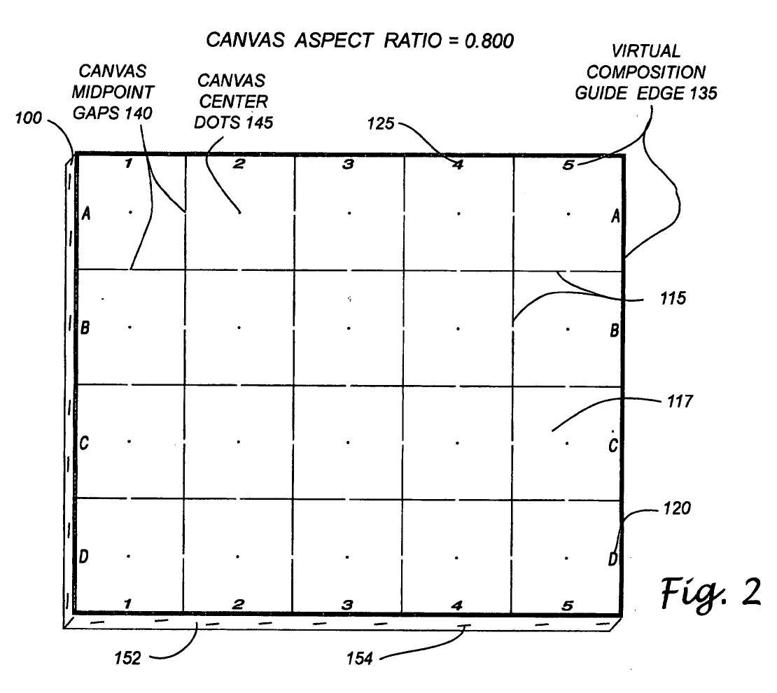

FIG. 1 illustrates a preferred image guide 5 on a substantially clear substrate 10 advantageously formed from a plastic sheet such as polycarbonate or acetate approximately 0.004 inch thick of a type commonly used for producing transparencies using laser copiers and printers, and which is readily available at low cost. Such sheets are available from Apollo Co., 60 Trade Zone Court, Ronkonkoma, N.Y. 11779, USA, and provided in package PP100C.

To manufacture image guides, the lines and features may be imprinted using a laser printer. To discourage illegal copying of image guides onto plastic sheets, substantially non-copyable image guides may be produced using white ink or paint in a silk screen process, or white toner material made with titanium dioxide, for example, for a copying machine such as is available from KLE, P.O. Box 2452, Jupiter, Fla. 33468, USA; Tel: (561)743-0636. Laser printing may be accomplished using a Lexmark printer model number 4039 10 Plus, also available through KLE noted above.

Image guide 5 of FIG. 1A includes a series 20s grid pattern composed of horizontal and vertical grid lines 15 which form an array of twenty image guide cells 17. Cells 17 may preferably be squares. Subdivision reference indicator center dots 45 and subdivision reference indicator midpoint gaps 40 increase the effective number of cells 17 without the intimidation and confusion of a larger numbers of cells. Cells 17 are identified as the intersection of columns with column labels 25, and rows with row labels 20. A bold rectangular composition guide 30 having an aspect ratio of 0.800 in the preferred embodiment encloses the twenty cells 17 and encloses the major portion of the composition of an image, not shown, upon which it is overlaid. Dotted image guide extension grid lines 50 extend beyond the composition guide 30 to aid artists while drawing into partial cells and cells external to the composition guide on canvases of aspect ratios other than 0.800.

Image guide 5 of FIG. 1A is advantageously a member of a set of graduated image guides, tabulated in Table I, wherein each image guide is labeled according to its increasing size. In one preferred embodiment, the set includes 15 image guides with a linear size step of 12.25% from one image guide to the next in the set. Each image guide 5 is labeled with a label number 55, that number being 13 in the example shown in FIG. 1A.

TABLE I
Set of Fifteen Series 20s Image Guides with Cell
and Composition Guide Dimensions.

| | | | Composition | Useable also as a |
|---|---|---|---|---|
| Image | Cell | Composition | Guide | detail guide for a |
| Guide | Side, | Guide Height | Width | Primary Image |
| Label | Inch | inches | inches | Guide Labeled: |
| 1 | 0.40 | 1.60 | 2.00 | 7 |
| 2 | 0.445 | 1.78 | 2.23 | 8 |
| 3 | 0.500 | 2.00 | 2.50 | 9 |
| 4 | 0.561 | 2.24 | 2.81 | 10 |
| 5 | 0.630 | 2.52 | 3.15 | 11 |
| 6 | 0.707 | 2.83 | 3.54 | 12 |
| 7 | 0.794 | 3.17 | 3.97 | 13 |
| 8 | 0.891 | 3.56 | 4.45 | 14 |
| 9 | 1.000 | 4.00 | 5.00 | 15 |
| 10 | 1.122 | 4.49 | 5.61 | |
| 11 | 1.260 | 5.04 | 6.30 | |
| 12 | 1.414 | 5.66 | 7.07 | |
| 13 | 1.588 | 6.35 | 7.94 | |
| 14 | 1.782 | 7.13 | 8.91 | |
| 15 | 2.000 | 8.00 | 10.00 | |

Referring to FIG. 1C, it is desirable to provide detail image guides 6 for each of the large, or primary, image guides 5 so that the large cells 17 may be divided into four, for example, smaller detail cells 18 using one of the smaller image guides 6 in the set.

Table I indicates that image guides labeled 1 through 9 are useable also as detail guides. FIG. 1C detail guide reference 60 is enlarged in FIG. 1B and identifies the image guide with label 56 that is useable as a detail guide for the primary image guide 5. The smaller image guide 6 detail cells 18 are spatially related by one-half to cells 17 of the primary image guide 5. Detail center dots 46 and detail midpoint gaps 41 accurately locate detail elements of the image, not shown. Product information 78 may also be applied to image guide 5.

It is desirable to include 0.500 inch, 1.00 inch, and 2.00 inch grid spacing in the image guide set of Table I and for the set to span a grid range of approximately 0.40 inch to 2.0 inches as found to be practical by experience of artists and students. Defining:

p=increase in edge dimension per image guide step, percent, such as 12.25%;

n=number of image guide sizes between any detail guide and its corresponding large image guide, such as 6;

d=number of subdivisions a detail guide divides its corresponding large image guide into, such as 2.

Then the size step, p, is found from:

p=100×((d)^{1/n}−1)% [1]

Since the preferred embodiment image guides 5 are series 20s, all of which share the identical composition guide shape with aspect ratio 0.800, the same pattern may be applied to all canvases of that shape, regardless of the canvas size. That is, an 8-inch by 10-inch canvas will have rows A through D and columns 1 through 5, as will a 16-inch by 20-inch canvas and a 32-inch by 40-inch canvas. The larger the canvas, the larger the individual grid line spacing will be.

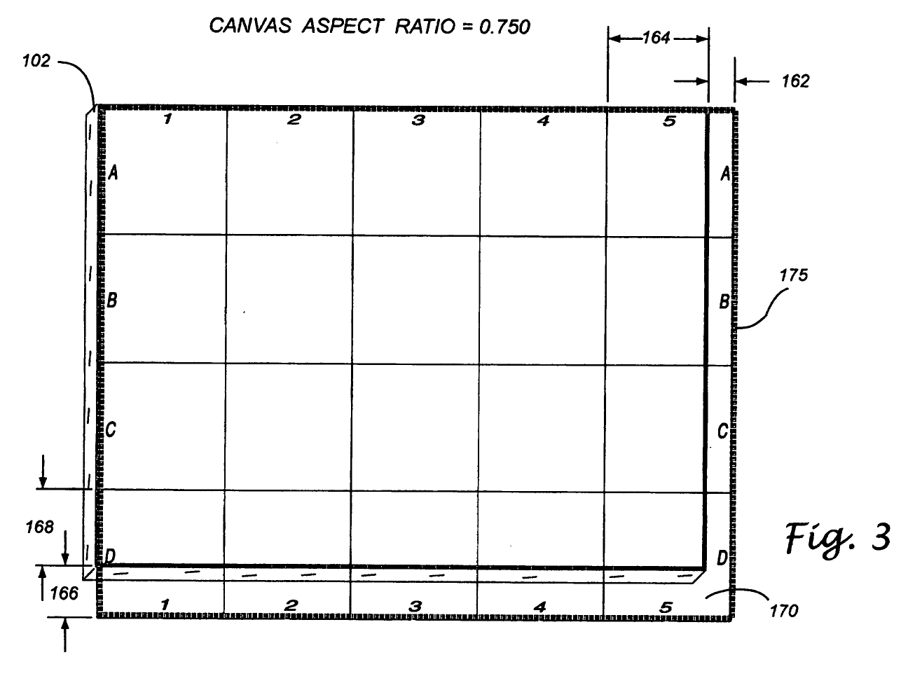

FIG. 2 represents all canvases 100 of aspect ratio 0.800 gridded for use with series 20s image guides 5. It is seen that this canvas shape with series 20s markings has an integral number of rows and columns, with no fractional (partial) cells. Canvas 100 includes a fabric stretched over a frame as described below in conjunction with FIG. 15. The fabric is secured along sides 152, typically with staples 154 or the fabric may be folded to the back side and secured with frame plugs and glue or the like, not shown, and well established in the art. In some cases sides 152 are substantially deeper and may be painted, although the paintable area of the canvas 100 is considered herein to be its front surface. Canvas gridding includes horizontal and vertical canvas grid lines 115.

Canvas column labels 125, and canvas row labels 120 relate to image guide column labels 25 and image guide row labels 20, respectively, of FIG. 1A, and form twenty square cells such as canvas cell 117 which relates to image guide cell 17 of FIG. 1A. Virtual composition guide, edges 135 represent composition guide 30 of FIG. 1A but are advantageously not imprinted onto canvas 100 since the four edges of canvas 100 are useable as a canvas composition guide.

Canvas subdivision reference indicators include canvas midpoint gaps 140 and canvas center dots 145 which relate to midpoint gaps 40 and center dots 45 of FIG. 1A image guide 5. FIG. 3 illustrates an 18-inch by 24-inch canvas 102 of a very common shape having aspect ratio 0.750. The gridding of this canvas 102 according to Ref (1) involves the use of a canvas ruler and canvas table specific for series 20, not shown. Such canvas table would define a 5.0 inch grid spacing for canvas 102. If the canvas grid pattern is attempted to be drawn onto canvas 102, the entire projected pattern would be 20 inches by 25 inches, extending beyond the canvas edges in overlap region 170 as illustrated with imaginary canvas composition frame 175. Thus for canvas 102 there are fractional or partial cells in column 5 of width 164 and in row D of height 168. Column 5 overlap 162 is 1.0 inch (25 inches less the actual canvas 24 inches), and row D overlap 166 is 2.0 inches (20 inches less the actual canvas 18 inches) for the instant canvas and grid sizes.

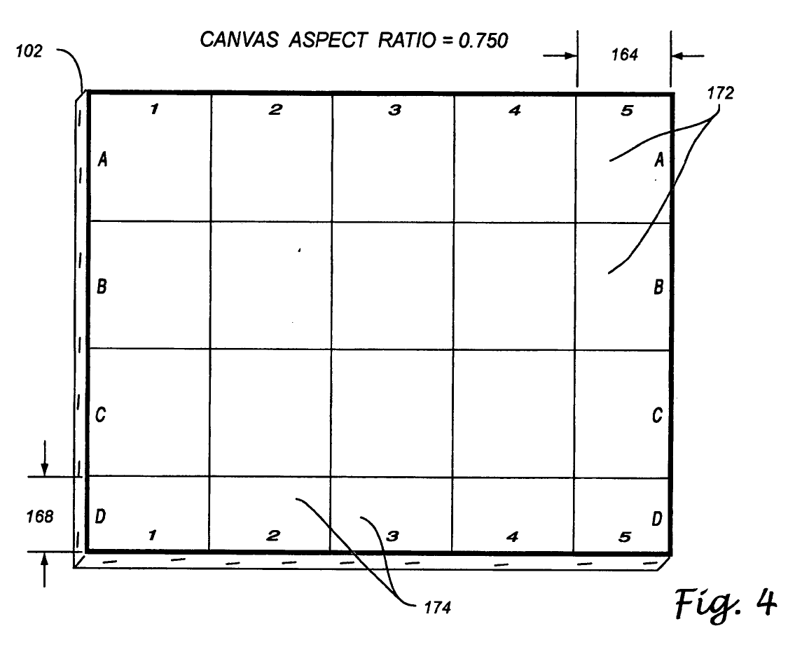

FIG. 4 illustrates the 18-inch by 24-inch canvas 102 of FIG. 3 as gridded according to Ref (1) series 20. The series 20s pattern of the present invention, not shown in FIG. 4, includes also subdivision indicators as described above. Column 5 partial cell width 164 is 4.0 inches (5 inch grid less 1 inch overlap 162 of FIG. 3) and row D partial cell height 168 is 3.0 inches (5 inch grid less 2 inch overlap 166 of FIG. 3). It is readily seen that such horizontally-partial cells 172 and vertically-partial cells 174 can lead to confusion, and may require a user to employ the corner-guide of Ref (1), an undesirable complication of the use of Ref. (1) Drawing Aid.

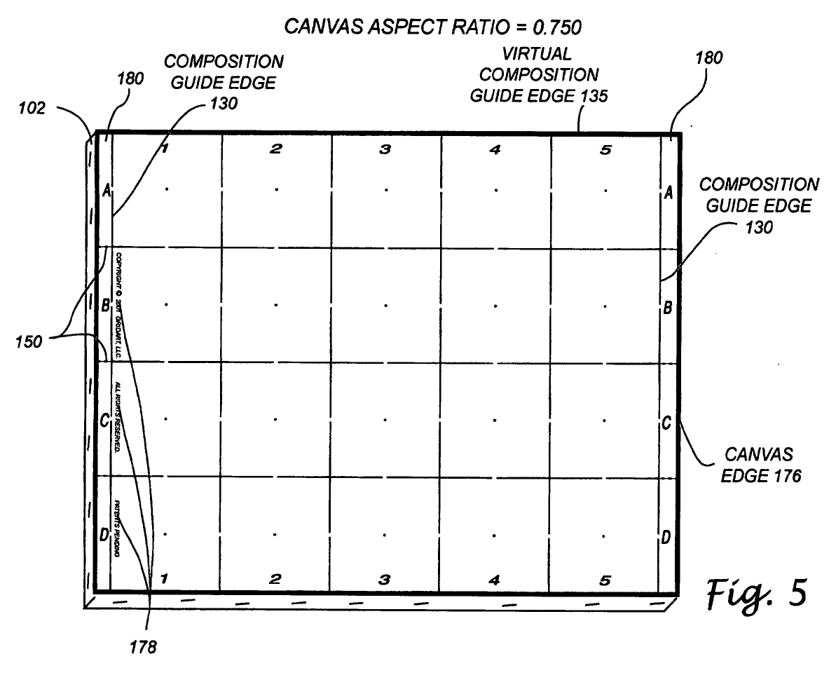

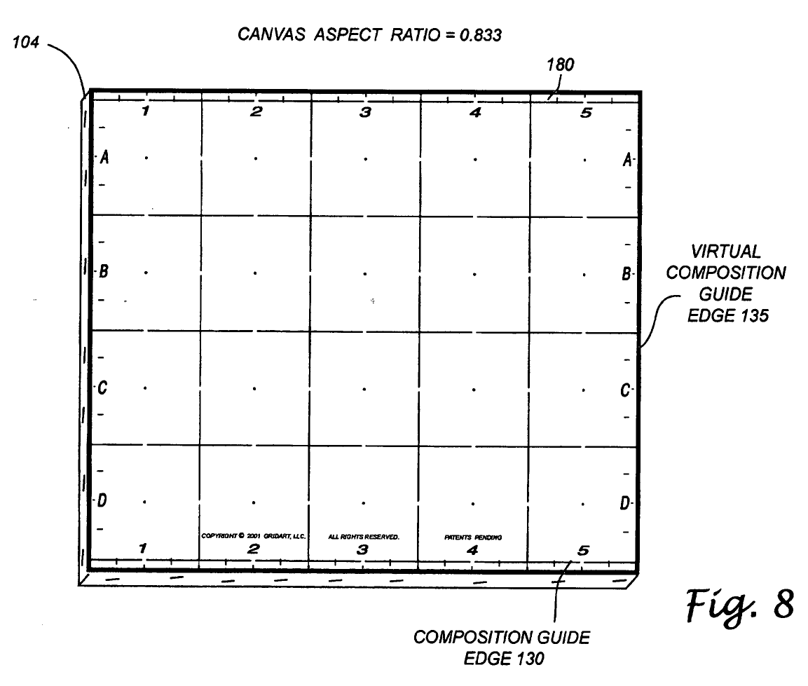

FIG. 5 illustrates an 18-inch by 24-inch canvas 102 gridded according to one preferred embodiment of the present invention, a series 20s grid pattern. To minimize the fractional or partial cell area of canvas 102 while maintaining a full canvas composition guide within the bounds of canvas 102, canvas grid size is adjusted so that an integral number of canvas grids is created in either the vertical or horizontal direction (the vertical direction in this case). If one imagines a small rectangle of the image guide aspect ratio (0.800) well within the bounds of the canvas, and then imagines the rectangle gradually enlarging while maintaining its shape (aspect ratio) but staying within the canvas, the point at which the rectangle first touches both opposing edges in either the horizontal or vertical direction is the point at which the size of the rectangle is maximized, and is defined as the canvas composition guide. This point then defines the canvas grid size, which establishes the cell size. Partial cells 180 will be either vertically-partial (“short” canvases of aspect ratios greater than 0.800 in Table II below, such as in FIG. 8 discussed below) or horizontally-partial (“long” canvases of aspect ratios less than 0.800 in Table II below, such as in FIG. 5). Small partial cells 180 represent border regions for artists to extend their drawing somewhat beyond the 4-row by 5-column array of 20 cells that is centered on the canvas. Dotted canvas grid line extensions 150 are useful in partial cell regions to guide artists. Product information 178 may also be applied to the canvas.

The general method for calculating the square cell size for any rectangular canvas is as follows, using any measurement unit as long as it is consistent:

Let

G=canvas grid size;

H=canvas height;

W=canvas width;

The height is defined as the smaller of the two canvas side dimensions, therefore H≦W;

A=aspect ratio of the image guide series to be used (such as 0.800 for series 20s);

C=aspect ratio of the canvas to be gridded;

C=(canvas height)/(canvas width)=H/W;

Nr=number of rows in the image guide series, such as 4;

Nc=number of columns in the image guide series, such as 5;

P=fraction of a grid, split into two rows or columns and distributed on opposite sides of the canvas composition guide.

Step 1. Calculate aspect ratios A and C.

Step 2. If C=A, G=H/Nr; canvas has same shape as composition guide, such as 0.800 aspect ratio.

If C<A, G=H/Nr; a “Long” canvas and

P={0.5×(W−G×Nc)/G} of a cell in width.

If C>A, G=W/Nc; a “Short” canvas and

P={0.5×(H−C×Nr)/G} of a cell in height.

TABLE II
Various Drawing Tablet and Canvas Sizes (inches) Showing
Aspect Ratios, Calculated Cell Size, and Partial CellFractions.

| | | | | Partial Grid | Partial Grid |
|---|---|---|---|---|---|
| | | Aspect | | Fractions | Fractions |
| Height | Width | Ratio | Grid Size | Long* | Short* |
| 4 | 5 | 0.800 | 1.000 | | |
| 4 | 6 | 0.667 | 1.000 | 0.500 | |
| 5 | 7 | 0.714 | 1.250 | 0.300 | |
| 6 | 8 | 0.750 | 1.500 | 0.167 | |
| 6 | 9 | 0.667 | 1.500 | 0.500 | |
| 8 | 10 | 0.800 | 2.000 | | |
| 9 | 12 | 0.750 | 2.250 | 0.167 | |
| 11 | 14 | 0.786 | 2.750 | 0.045 | |
| 12 | 16 | 0.750 | 3.000 | 0.167 | |
| 12 | 24 | 0.500 | 3.000 | 1.500 | |
| 14 | 17 | 0.824 | 3.400 | | 0.059 |
| 15 | 30 | 0.500 | 3.750 | 1.500 | |
| 16 | 20 | 0.800 | 4.000 | | |
| 16 | 18 | 0.889 | 3.600 | | 0.222 |
| 16 | 22 | 0.727 | 4.000 | 0.250 | |
| 18 | 24 | 0.750 | 4.500 | 0.167 | |
| 18 | 36 | 0.500 | 4.500 | 1.500 | |
| 20 | 24 | 0.833 | 4.800 | | 0.083 |
| 22 | 28 | 0.786 | 5.500 | 0.045 | |
| 20 | 32 | 0.625 | 5.000 | 0.700 | |
| 24 | 30 | 0.800 | 6.000 | | |
| 24 | 36 | 0.667 | 6.000 | 0.500 | |
| 30 | 36 | 0.833 | 7.200 | | 0.083 |
| 30 | 40 | 0.750 | 7.500 | 0.167 | |
| 30 | 48 | 0.625 | 7.500 | 0.700 | |
| 36 | 36 | 1.000 | 7.200 | | 0.500 |
| 36 | 40 | 0.900 | 8.000 | | 0.250 |
| 36 | 48 | 0.750 | 9.000 | 0.167 | |
| 40 | 48 | 0.833 | 9.600 | | 0.083 |
| 36 | 60 | 0.600 | 9.000 | 0.833 | |
| 40 | 60 | 0.667 | 10.000 | 0.500 | |
| 56 | 64 | 0.875 | 12.800 | | 0.188 |
| 48 | 60 | 0.800 | 12.000 | | |
| 48 | 48 | 1.000 | 9.600 | | 0.500 |
| 60 | 72 | 0.833 | 14.400 | | 0.083 |
| 72 | 96 | 0.750 | 18.000 | 0.167 | |

*“Long” canvases (e.g. FIG. 5) have a smaller aspect ratio than the image guide series such as 0.800, whereas “Short” canvases (e.g. FIG. 8 are more square appearing)

For example, for series 20s, A=0.800, Nr=4 rows, and Nc=5 columns. For an 18 inch by 24 inch canvas, H=18 inches and W=24 inches. C=18/24=0.750. C<A, so that G=H/Nr=18 inches/4=4.50 inches which is the grid size, and the canvas is “Long.” P=0.5×(24 inches−4.50 inches×5 columns)/4.50 inches=0.17 of a cell side. When dividing the partial cell area and distributing it on both ends of the composition guide, the partial grid width is 0.17 of a cell in size (0.75 inch with the 4.50 inch cell size). Composition guide edges 130 are printed on left and right sides of canvas 102, whereas virtual composition guide edges 135 are represented by the canvas edge itself and are advantageously not printed onto canvas 102.

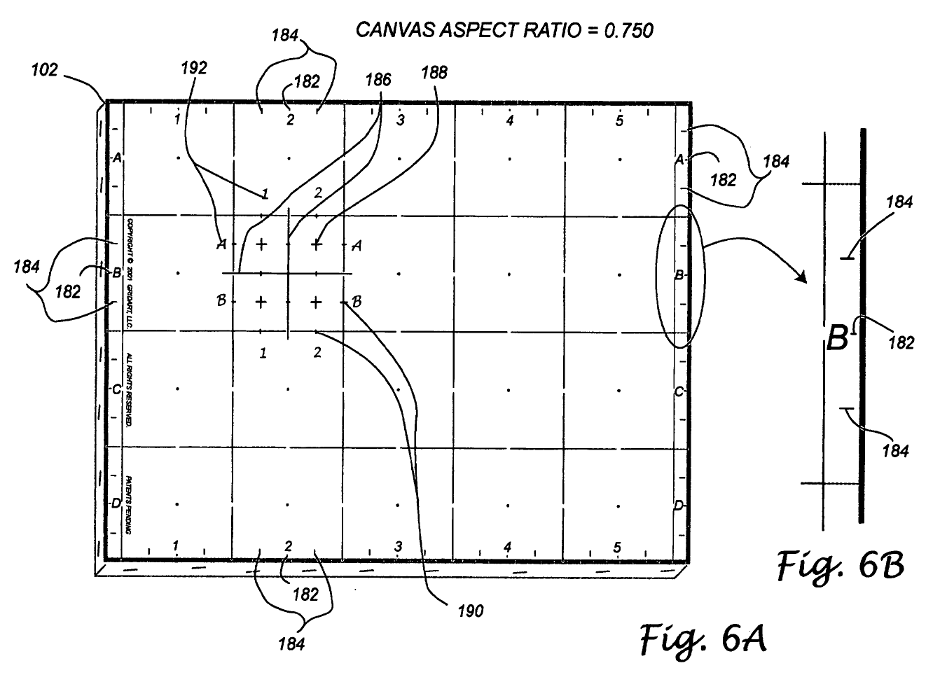

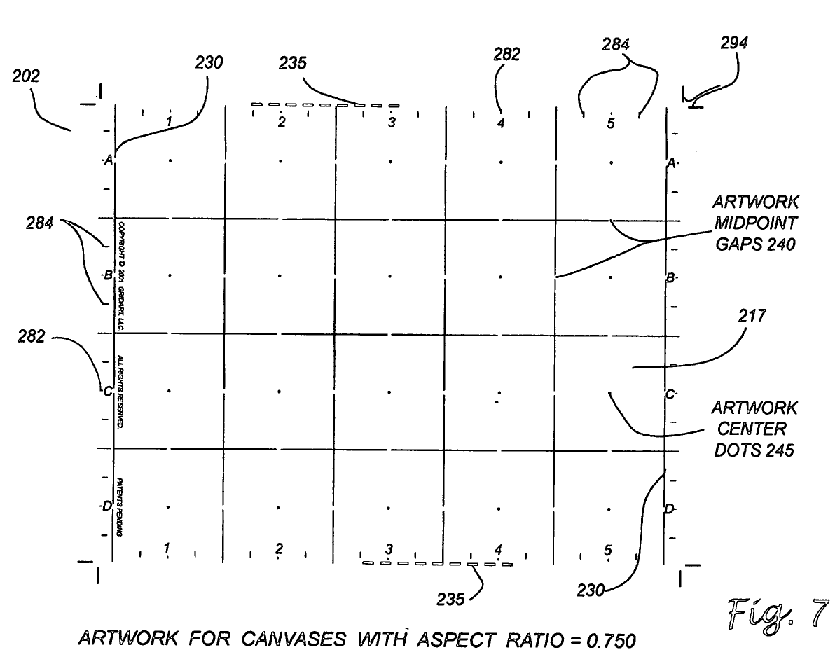

FIG. 6A introduces one of the innovations of the present invention, canvas edge detail guide marks silk-screened onto canvas 102 for easily constructing canvas detail grid patterns useable with detail guides illustrated in FIG. 1C. These canvas edge guide marks are expanded for clarity in FIG. 6B. Canvas edge center guide marks 182 may be provided near all canvas edges to allow manual construction of detail grid lines 186 by the user with the aid of a straight-edge, not shown, through the canvas midpoint gaps and center dots previously described. Alternatively, center dots alone may be used to generate detail grid lines 186. Canvas edge detail guide marks 184 provided near all edges of the canvas allow accurate manual construction of detail center dot indicators 188 by the user to correspond to detail center dots 46 of FIG. 1C of the detail guide positioned over the image guide previously discussed. Such detail grid lines 186, detail dot indicators 188, and also detail row and column labels 192 may be manually constructed by the user with pencil, to later be erased, or preferably with a writing pen containing water soluble ink similar to that used for silk screening of the grid patterns and described below. At his option, a user may also generate detail gap indicators 190 to correspond to detail midpoint gaps 41 in the detail guide cells used as described above in FIG. 1C.

It should be understood that all other canvas sizes of aspect ratio 0.750 will exhibit a similar appearance and will include partial cells similar in shape to those of FIG. 6A when gridded according to the present invention preferred embodiment series 20s pattern.

FIG. 7 illustrates artwork 202 for silk screening the pattern for 0.750 aspect-ratio canvases 102 of FIG. 6A, showing the artwork for the silk screen pattern isolated from the canvas for clarity. Artwork detail guide marks 284 and artwork center guide marks 282 may be placed outside of the composition guide whenever there is sufficient room, such as outside the extreme left and right vertical grid lines 230. However when the non-printed dashed lines 235 representing the virtual such as outside the extreme left and right vertical grid lines 230. However when the non-printed dashed lines 235 representing the virtual composition guide edges 135 of FIG. 5 are represented by the canvas edges, it is necessary to place the guide marks and labels inside the virtual composition guide, as seen at the top and bottom edges of artwork 202. Crop marks 294 identify the artwork extremes that align with the four canvas edges helpful in aligning the silk screen to canvas locating fixtures described below. The non-printed dashed lines 235 represent the location of virtual top and bottom horizontal grid lines that are not silk-screened, but are implied by the top and bottom edges 135 of canvas 102 as described with respect to FIG. S. The composition guide 30 of FIG. 1 is reflected in FIG. 7 as a rectangle formed by non-printed dashed lines 235 extended to join with left and right extreme vertical gridlines 230. It should be understood then that artwork 202 of FIG. 7, when used to create a screen, not shown, for silk screening, described below, of a canvas of aspect ratio 0.750 will result in canvas 102 of FIG. 6A when the screen is properly aligned to the corners of the canvas and the canvas is painted with the silk screen process.

FIG. 8 illustrates canvases of aspect ratio 0.833 wherein precisely five columns are fitted between the left and right sides of canvas 104, and small partial cells 180 occur at the top and bottom constructed according to the present invention wherein artists extend their drawing somewhat beyond the full 4-row by 5-column array of 20 cells in order to accommodate the aspect ratio difference between the 0.833 aspect ratio canvas 104 and the 0.800 aspect ratio image guide composition guide. Thus the border grid lines, which here are the virtual composition guide edges 135 that are not silk-screened but are represented by the left and right extreme edges of canvas 104, represent the left and right portions of composition guide 30 of FIG. 1A. Composition guide edges 130 are within the canvas area and are silk-screened thereon.

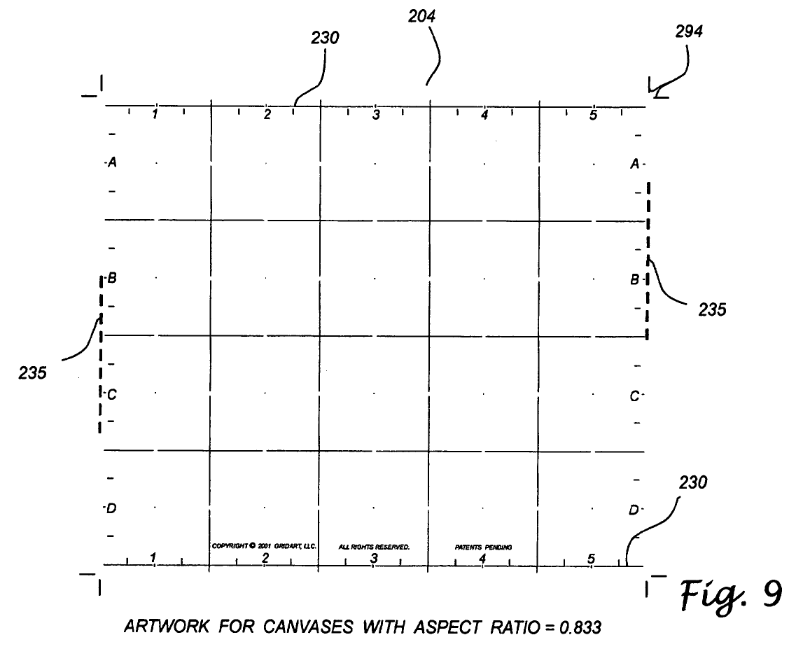

FIG. 9 illustrates artwork 204 for silk screening the pattern for 0.833 aspect-ratio canvases of FIG. 8 such as 20×24 inch canvases and 50×60 centimeter canvases and the like. Composition guide edges 130 of FIG. 8 are represented by top and bottom extreme horizontal grid lines 230. Left and right vertical composition guide edges shown partially as dashed lines 235 at the left and right edges are not printed, but indicate the location of canvas 104 left and right edges forming virtual composition guide edges 135 of FIG. 8 when artwork 204 is used in creating the silk screen pattern for canvas 104 of FIG. 8. Thus the border grid lines, which here are the left and right vertical grid lines that are non-existent in the silk screen but are represented by dashed lines 235 locating the left and right edges of a canvas to which this artwork is applied, represent the left and right portions of composition guide 30 of FIG. 1.

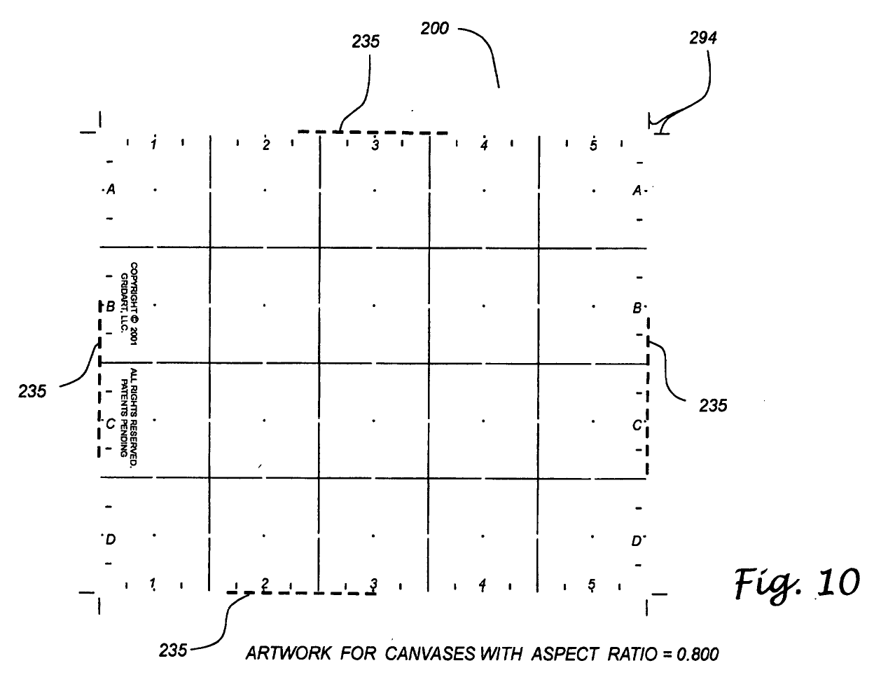

FIG. 10 illustrates artwork 200 for silk screening the pattern for 0.800 aspect-ratio canvases such as 8×10, 16×20, 24×30 inches, 48×60 centimeters and the like. Composition guide 30 of FIG. 1 is represented by virtual composition guide edges 235 shown as partial non-printed dashed lines in FIG. 10 at all four extreme edges that align with crop marks 294 and with the four edges of a 0.800 aspect ratio canvas to which this artwork is applied.

So it is seen that composition guide 30 of FIG. 1 may be represented, in whole or in part by canvas edges. This representation of composition guide 30 on a canvas simplifies the silk screen process by eliminating ink at the extreme canvas edges.

Screens of varying pore density are used in silk screen processes well known in the art. Bleed, commonly used in the printing industry to print beyond a cut or fold, is disadvantageous in silk screening because ink or paint collects in the bleed region of the screen beyond the print area and smears onto the product. Therefore grid lines, guide marks, labels, and all other printing is purposefully and advantageously stopped close to the edges seen in the artwork of FIGS. 7, 9, and 10 when the printing extremes are observed with respect to the crop marks. Crop marks are covered with tape, not shown, on the silk screen itself, not shown, to avoid ink therefrom contacting the canvas. Other preferred embodiments, such as printing of canvas fabric prior to attaching the canvas fabric to a frame and printing on watercolor and drawing paper may include visible grid lines representative of composition guide 30 of FIG. 1 within the scope of this invention.

Table II above identifies many of the most common sizes and aspect ratios of drawing tablets and canvases. It is seen that aspect ratios of 0.800 and 0.750 are very common, and that aspect ratios ranging from 0.500 (2:1) to 1.00 (square) are available.

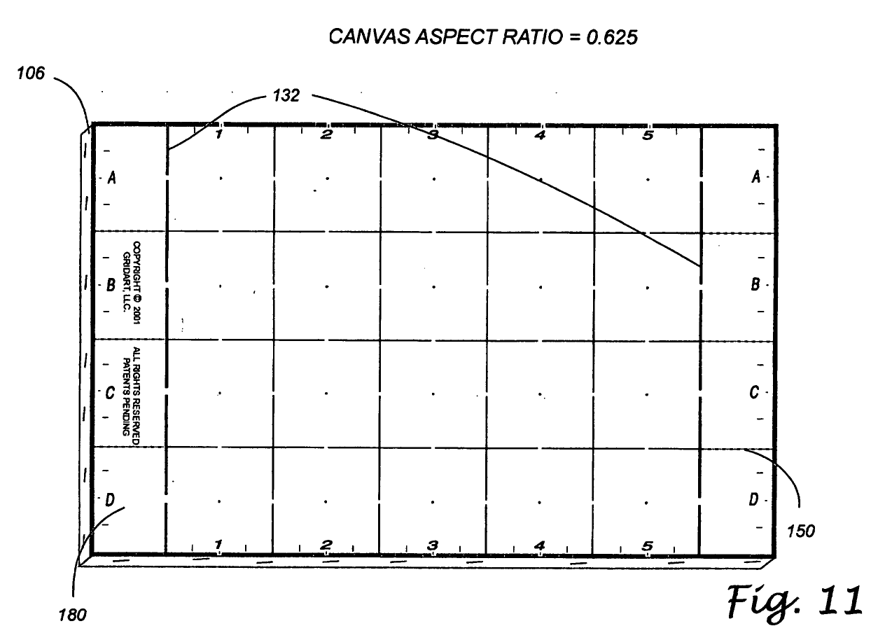

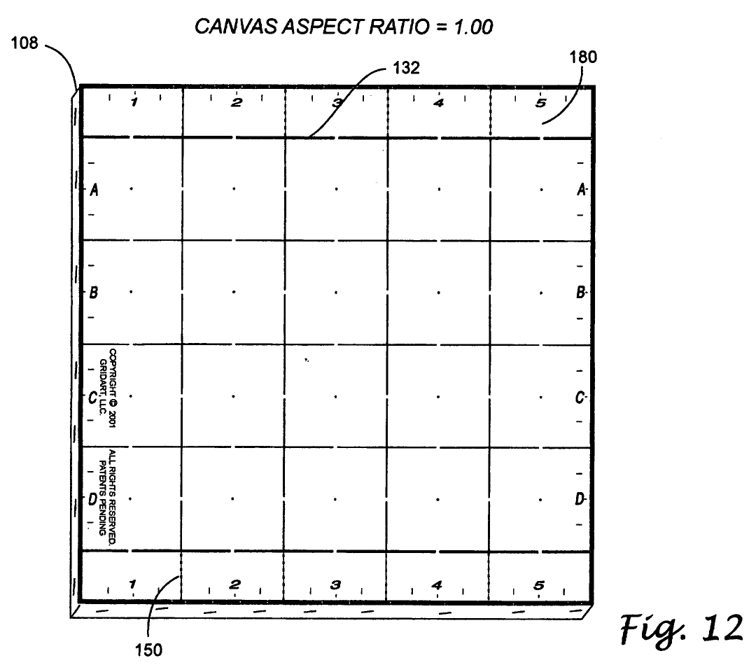

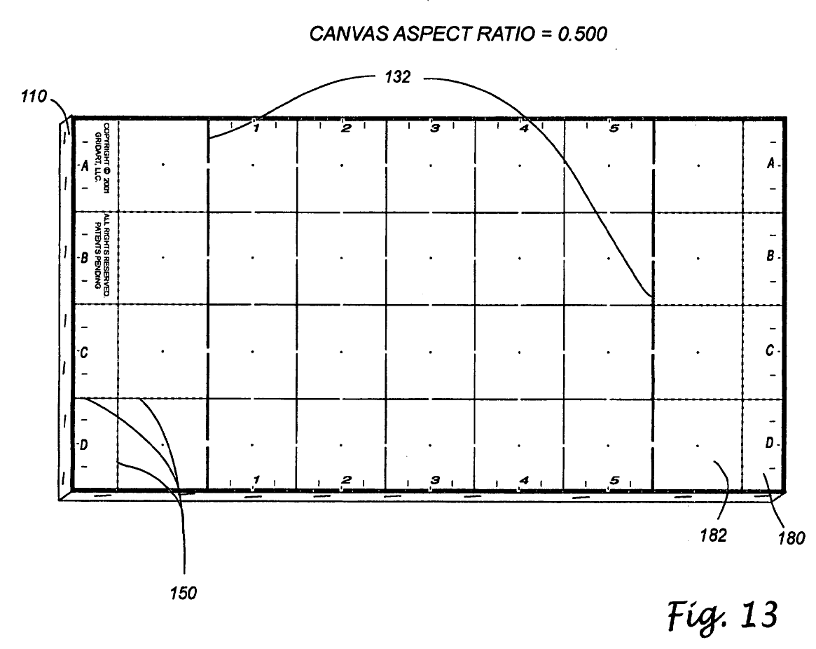

Some of the extremes in shapes and partial cells are illustrated in FIGS. 11 through 13 wherein partial cells may be accompanied by full cells external to the canvas composition guide. FIG. 11 illustrates canvases 106 of aspect ratio 0.625 with large partial cells 180 and grid line extensions 150 such as a 30-inch by 48-inch canvas, wherein even though large, the partial cells are clear and easy to extend the drawing beyond bold composition guide edges 132. FIG. 12 illustrates pre-gridded square canvases 108 with bold composition guide edges 132, partial cells 180, and grid line extensions 150. FIG. 13 depicts canvas 110 with a 2:1 shape (aspect ratio 0.500) such as 12-inch by 24-inch and 15-inch by 30-inch canvas versions, and illustrates partial cells 180, external cells 182, and grid line extensions 150 wherein bold composition guide edges 132 may be printed bold to clearly identify the central composition region.

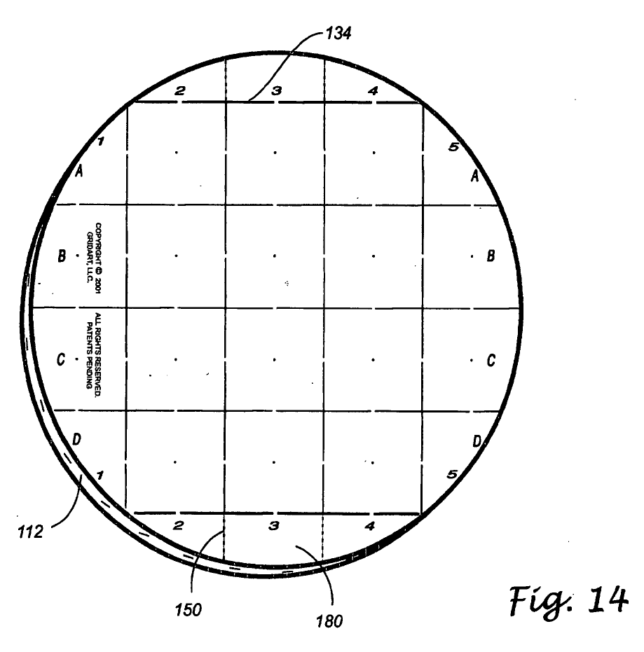

The grid pattern of square canvas 108 of FIG. 12 may be applied to circular canvas 112 gridable with the system, as a special case wherein the canvas composition guide is no longer totally enclosed within the canvas, as illustrated in FIG. 14. Partial cells 180 are shown, grid line extensions 150 may be printed onto the canvas as shown, and partial composition guide edges 134 help the user compose the work of art.

Other canvas shapes, not shown, such as ovals, may be gridded following the method of gridding circular canvas 112 based upon square canvas 108 wherein the oval shape may be centrally contained and maximized in size within an appropriate rectangular canvas pattern, where, for example, the oval or elliptical shape major and minor axes are substantially equal to the reference canvas width and height respectively.

Often canvasses are manufactured with a primer coating of clear acrylic applied to the canvas fabric, called “Gesso”, a process well known in the art field, to improve the surface texture and absorption properties for painting. Such a coating is beneficial in applying an ink that is removable, since the ink is then not deeply absorbed into the canvas material. The preferred embodiment includes a Gesso coating or the like.

Commonly used quilting inks become invisible when exposed to polar solvents such as water. However, it has been found that even with considerable scrubbing, once the canvas dries, the quilting ink pattern returns, and may later be visible under paint. Poster paints, known in the industry, are only somewhat washable. Such inks are substantially removed with vigorous washing in soap and water but are not preferred for this application since forceful scrubbing is required to remove all traces of that ink and therein may damage or destroy the drawing.

A relatively high viscosity of approximately 5,000 centipoises (cps) to 40,000 cps is required in silk screen processes to inhibit excessive ink or paint flow-through while still allowing for convenient manipulating of the ink or paint fluid with a squeegee across the screen, following methods well known in the art. Thus an appropriate ink should include material to provide appropriate viscosity, and such material should advantageously be very soluble in water. Hydroxypropyl Methyl Cellulose (HPMC), well known in the chemical industry and available from Sigma-Aldrich, 6000 North Teutonia Avenue, Milwaukee, Wis. 53209, catalog number 423173, is a low cost material made from wood pulp, is non-toxic and biodegradable. Dissolving HPMC as a base in distilled water as solvent forms a viscoelastic gel that may easily be adjusted to tailor the ink viscosity, and once dried is readily re-dissolved by passing a wetted sponge thereover.

I found that adding a water soluble dye, such as USP Class 6 dyes used in food coloring, allowed adsorption of the dye onto the canvas Gesso surface acrylic coating, such that later rinsing would not remove all of the color. Such dyes also bleach when exposed to sunlight. I discovered that use of a pigment substantially insoluble in water, and of particle size sufficiently small to allow ready suspension in water and in the HPMC gel, easily washed away by passing a wetted sponge over the dried and pigmented gel. Ultamarine Blue powder, supplied as a dry pigment for paint, available as PB29 from Gambian Artists Colors Co. PO Box 625, Portland Oreg. 97207, was discovered to possess these qualities. This material is a complex silicate of sodium and aluminum with sulfur and is supplied as a very fine powder. This material is robust and substantially does not fade or bleach when exposed to direct sunlight for long periods.

Elastomer or gum erasers commonly used in the drawing field can be utilized to erase errors in the drawing, substantially without modifying my pre-printed grid lines which, when the drawing is complete, are very robust when dry. Prior art requires tedious erasure of all grid lines and all labels, while carefully dodging the drawing elements. This step in the drawing/painting process is inefficient and a waste of the artist's time, and can lead to great frustration.

In typical silk screen processes, screens with mesh densities ranging from about 60 apertures per inch to about 300 apertures per inch are used. Typically the larger apertures, such as 60 to 80 apertures per inch are used for silk screen onto very porous materials such as sweatshirts and the like. The finer mesh sizes, such as 140 to 300 are used for silk screening onto smooth materials such as paper and metals. It is important to maintain a high resolution of the grid artwork for two reasons. First, the lines and labels should not obscure excessive area of the canvas for drawing, since the grid lines and labels will be removed in the washing process, also removing drawing lines passing over the removable ink. Second, it is desirable to insure that the grid washing process is rapid, and this requires that the ink be placed down with small line widths so that the dissolving process can be rapid without the requirement of lengthy soaking or abrasive scrubbing that tends to remove details of the drawing, generally done with graphite pencils. Line widths between the range of approximately 0.020 inch to 0.050 inch have been found appropriate for use with a preferred silk-screen mesh density of 140 apertures/inch.

Well known silk-screen processes involve a screen mesh coated with a photosensitive material that is exposed with light to establish fixed regions and non-fixed regions corresponding to artwork patterns. After curing and washing, good durability of the fixed regions of the photosensitive material is important to allow repeated and sustained use of the silk screen in large production without degradation of the pattern. Common photosensitive material useable for both oil-based and water-based silk-screen paints was found appropriate and durable with the ink of this invention.

By adjusting the viscosity of my ink gel I was able to experiment with various screen aperture densities while looking for high detail deposition of the ink gel onto the canvas surface. I found that, for workable ranges of viscosity, the coarser mesh screens performed poorly and created blotchy areas not accurately representing the gridding artwork. I also found that the gel did not flow through the higher density screens easily. I discovered that a wetting agent was very helpful in transferring the gel through the screen mesh while preserving fine detail. The addition to my ink of a wetting agent resulted in the best performance, when using a common liquid hand soap. One of the benefits found may result from a moisturizing agent, Aloe, in the hand soap used. It was discovered that with relatively large hand soap concentrations, the mechanical “pulling” process as the squeegee is pulled across the screen with the ink “felt” much smoother and did not seem to “grab” according to the silk-screen technician. Excessive concentration of hand soap, however, created a combination described as “too slippery” by technicians experienced in the silk screen field. Thus the hand soap reduces the friction and provides a feel much like standard silk-screen paints, since it facilitates the ink to flow through the apertures of the silk screen.

I discovered an additional benefit to the use of hand soap within the ink chemistry, namely, that later washing away the grid patterns is further assisted by the wetting agent, which is a surfactant, as the suspended colorant is lifted from the surface. A preferred hand soap for this use is Softsoap® manufactured by Colgate-Palmolive, Morristown, N.J. 07962-1905, USA, phone 800432-8226.

I have identified my water soluble gel ink as “GridArt™ Ink”. The chemistry and procedure for mixing GridArt™ Ink is:

1. Thoroughly mix 15 grams of HPMC and 2 Tablespoons Ultramarine Blue colorant powder together while dry.

2. Heat 1.0 liter of distilled water to boiling, remove from heat source and gently mix into the water 3.33 Tablespoons of Softsoap®.

3. Slowly add the HPMC/colorant mixture from Step 1. into the water/soap mixture of Step 2. which should at this point exceed 80° C., and continue mixing gently until the temperature drops to less than 40° C.

4. Cover the mixture container and place into a common refrigerator overnight.

For use, the viscosity of GridArt™ Ink may be reduced if necessary by gently mixing small amounts of distilled water, particularly if the ink begins to dry out while in use in low-humidity high-temperature environments during the silk screen process.

It has been found that common polyester canvas fabric with Gesso coating is somewhat preferable over coarse canvas material with Gesso coatings as the destination base since the special ink is more readily removed with simple exposure to water. After drawing the source image likeness onto a pre-gridded canvas, the user dissolves the GridArt™ Ink by lightly wiping with a water-saturated sponge. Substantially all remnants of the grid lines and labels are washed away, while substantially all of the drawing remains.

Other uses for GridArt™ Ink will become apparent, such as children's toys, tee shirts with disappearing patterns, marking patterns for quilting and sewing, hose-washable store window painting, and other applications for disappearing ink, all within the scope of this invention.

Another element of this invention utilizes GridArt™ Ink diluted with approximately one part of distilled water to two parts of GridArt™ Ink, by weight, to create a disappearing writing ink. This writing ink may be introduced into ball point pens and the like, by methods commonly known in the field, and utilized for writing. Such instruments are useable to draw detail grid lines and labels on canvases so that they are easily removed when washing away the grids and labels from the canvases of this invention.

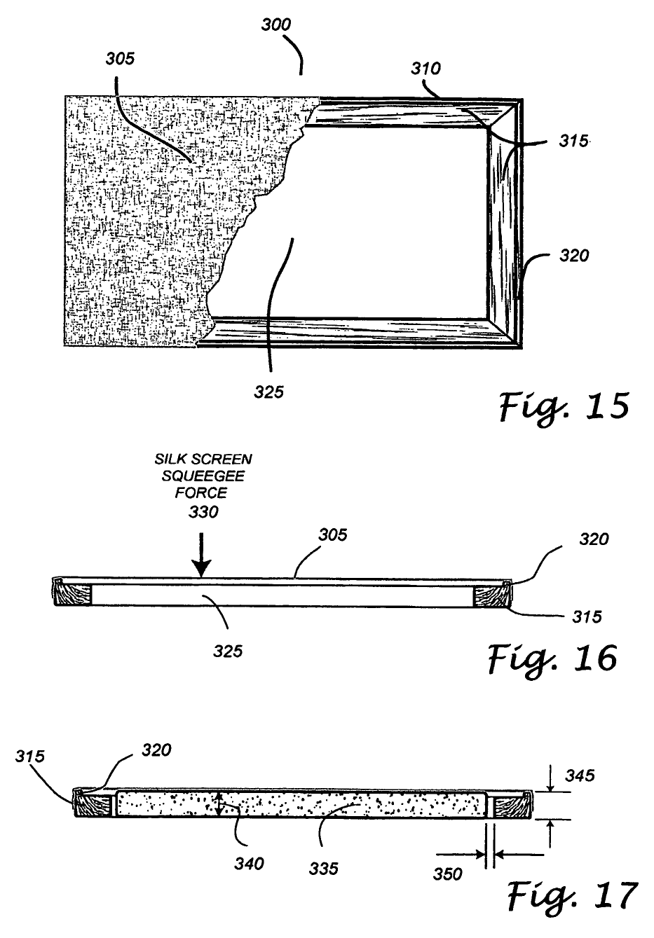

In silk screen processes it is necessary to support the material to be silk-screened. As illustrated in FIGS. 15 and 16, typically, a canvas 300 includes canvas surface fabric 305 stretched and secured over canvas frame 310 which may be constructed of wooden or plastic struts 315 with raised outer edge protrusions 320 that hold the canvas away from the remaining strut material. Canvas unsupported region 325 requires support behind canvas surface fabric 305 in order to prevent substantial deflection of material 305 from silk screen squeegee force 330 illustrated in FIG. 16. FIG. 17 illustrates canvas support 335 placed in the canvas unsupported region 325 of FIGS. 15 and 16 to provide support against the silk screen squeegee forces and substantially avoid canvas deflection too far away from the silk-screen, which would cause missing silk-screen pattern areas in the final product. Canvas support 335 may be made of particle board, plastic, metal or other materials commonly used in mechanical fixtures. The canvas support thickness 340 should be substantially the height of canvas frame 310 at the outer edge protrusions 320 as noted in dimension 345 of FIG. 17. Clearance 350 of approximately 1/32 inch all around between canvas support 335 and canvas frame 310 is provided. In the screening process, canvas 300 is pushed against one corner of support 335 which is located such that the canvas is then substantially centered upon the silk-screen pattern.

Although preferred water soluble ink applied by silk screening has been described, other disappearing canvas inks of other chemistries and applied by other methods are anticipated, and such embodiments are within the scope of this invention. Thus, while the invention has been described herein with reference to certain preferred embodiments, these embodiments have been presented by way of example only, and not to limit the scope of the invention. Accordingly, other embodiments and changes in form and detail may be made therein by one skilled in the art without departing from the spirit and scope of the invention, including embodiments which do not provide all of the benefits and features set forth herein.

What is claimed is:

1. A drawing system for facilitating the transfer of an image such as a photograph onto a canvas to create a work of art derived from the image in oil, water color, pencil, ink and the like, said system comprising:
a set of graduated image guides having arrays of cells and row and column labels so that each cell is identifiable by a unique row and column label designation, said image guides being adapted to be placed on the image to divide the image into a plurality of cells respectively identified by said row and column labels; and
subdivision reference indicators with said cells;

2. The drawing system of claim 1 including composition guides enclosing each of said arrays on each of the image guides of said set.

3. The drawing system of claim 1 including said canvas having a canvas array corresponding to said array of said image guides of said set.

4. The drawing system of claim 1 wherein said subdivision reference indicators include side reference indicators within each side of said cells.

5. The drawing system of claim 1 wherein said subdivision reference indicators include internal reference indicators within each of said cells.

6. The drawing system of claim 1 wherein said subdivision reference indicators include center dots and midpoint gaps.

7. The drawing system of claim 1 wherein at least one of said set of image guides is dimensionally related to another of said set of image guides, said image guide having a cell spatial one-half of said related image guide so that said image guide can be overlaid said dimensionally related image guide to provide a detail guide member for a portion of said dimensionally related image guide.

8. The drawing system of claim 3 wherein the canvas array is formed with a water soluble ink.

9. The drawing system of claim 3 wherein said canvas array is centered within a paintable area of the canvas and is scaled such that at least two sides of the array coincide with either vertical or horizontal edges of the paintable area of the canvas.

10. A drawing system for facilitating the transfer of an image such as a photograph onto a canvas and for facilitating the creation of a work of art derived from the image in oil, water color, pencil, ink and the like, said system comprising:
a set of graduated image guides having grid patterns of cells and row and column labels so that each cell is identifiable by a unique row and column label designation, said image guides being adapted to be placed on the image to divide the image into a plurality of cells respectively identified by said row and column labels;
said canvas having a canvas grid pattern corresponding to said grid pattern of said image guides; and
said canvas grid pattern formed with a water soluble ink.

11. The drawing system of claim 10 wherein said cells have subdivision reference indicators.

12. The drawing system of claim 10 wherein said subdivision reference indicators include center dots and midpoint gaps.

13. The drawing system of claim 10 wherein at least one of said set of image guides is dimensionally related to another of said set of image guides, said image guide having a cell spatial one-half of said related image guide so that said image guide can be overlaid said dimensionally related image guide to provide a detail image guide member for a portion of said dimensionally related image guide.

14. The drawing system of claim 10 wherein said canvas grid pattern is centered within a paintable area of the canvas and is scaled such that at least two sides of said canvas grid pattern coincide with either vertical or horizontal edges of the paintable area of the canvas.

15. The drawing system of claim 10 wherein said canvas includes edge detail guide marks and wherein a wetting agent is added to the water soluble ink to facilitate removal of said ink.

16. A drawing system for facilitating the creating of an image likeness onto a destination base derived from an image including:
a plurality of substantially transparent image guides adapted to overlay said image;
a grid pattern on each of said image guides having row and column labels;
said grid patterns increasing in size by a predetermined percentage from one image guide to the next;
said grid patterns including vertical and horizontal grid lines forming cells; and
said cells including subdivision reference indicators.

17. The system of claim 16 wherein a composition guide encloses each of said grid patterns.

18. The system of claim 16 including overlayable detail image guides for creating a likeness of fine detail wherein said detail image guides divide certain of column and row cells into a plurality of sub-cells.

19. The system of claim 16 wherein image guides are applied to clear substrates using white ink or white toner.

20. The system of claim 16 wherein each said grid pattern includes four rows and five columns.

21. The system of claim 16 including a canvas having a canvas grid pattern corresponding to the grid pattern on each of said image guides and including canvas edge detail marks.

22. The system of claim 21 wherein said canvas grid pattern is formed with a water soluble ink.

23. A method for drawing a likeness of an image onto a destination base comprising:
i. Overlaying a first image guide of a set onto said image; and
ii. Transferring scene information onto the destination base,
said first image guide comprising grid patterns with subdivision reference indicators and row and column labels printed on a substantially transparent sheet; said base including a grid pattern with subdivision reference indicators and row and column labels corresponding to the grid patterns with subdivision reference indicators and row and column labels of the image guide.

24. The method of claim 23 wherein (i) overlaying a first image guide onto said image includes:
i-a Replacing said first image guide with a second image guide of the set to adjust the area of the composition for the drawing, said second image guide larger or smaller than said first image guide by predetermined percentages.

25. The method of claim 23 wherein (ii) overlaying a first image guide onto said image includes:
i-b Translating said image guide horizontally and vertically to compose the drawing.

26. The method of claim 23 wherein said grid pattern of said destination base is applied thereon with a water soluble ink.

27. A water soluble ink for pens, brushes, printing, silk screening systems, and the like comprising:
distilled water as a solvent;
HPMC as a dryable base and to allow viscosity adjustment responsive to the HPMC concentration;
substantially insoluble colorant for visibility; and
a surfactant to enhance flow through apertures.
